(19) United States
(12) Patent Application Publication
(10) Pub. No.: US 2022/0156673 A1
(43) Pub. Date: May 19, 2022

(54) METHOD FOR PRODUCING AN ASSEMBLY

(71) Applicant: Volkswagen Aktiengesellschaft, Wolfsburg (DE)

(72) Inventors: Oliver WESSEL, Didderse (DE); Matthias HENSEL, Wolfsburg (DE); Otto SCHLUESCHE, Knesebeck (DE)

(73) Assignee: Volkswagen Aktiengesellschaft, Wolfsburg (DE)

(21) Appl. No.: 17/584,024

(22) Filed: Jan. 25, 2022

Related U.S. Application Data
(63) Continuation of application No. PCT/EP2020/070803, filed on Jul. 23, 2020.

(30) Foreign Application Priority Data
Jul. 25, 2019 (DE) 10 2019 120 167.5

(51) Int. Cl. G06Q 10/06; G06Q 50/04

(52) U.S. Cl. CPC G06Q 10/06398; G06Q 50/04

(57) ABSTRACT

A method for producing an assembly is provided such that manufacturing defects and redundant work steps are preventively avoided.

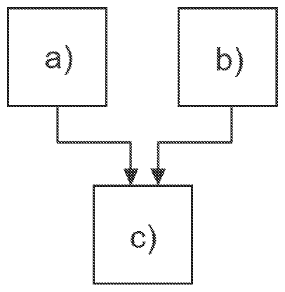

### METHOD FOR PRODUCING AN ASSEMBLY

This nonprovisional application is a continuation of International Application No. PCT/EP2020/070803, which was filed on Jul. 23, 2020, and which claims priority to German Patent Application No. 10 2019 120 167.5, which was filed in Germany on Jul. 25, 2019, and which are both herein incorporated by reference.

### BACKGROUND OF THE INVENTION

### Field of the Invention

The present invention relates to a method for producing an assembly and to an assembly.

### Description of the Background Art

When producing an assembly, individual parts are usually manufactured first, and these are then joined to form the assembly with the help of handling processes.

A number of problems can arise in this regard that reduce the quality of the assembly, for example, of a vehicle.

For example, parts can be damaged in the course of handling, which conventionally should be avoided by applying a prefabricated protective film after the parts have been manufactured. Such downstream work steps increase the cost, however.

Furthermore, vehicles, for example, are built conventionally on the basis of chains of reference points. The chains of reference points run, for example, from a hole in a side member to a centering of a headliner of the vehicle. An accumulation of tolerances of individual parts over this distance often leads to the vehicle being incapable of being assembled. For example, a fender, regarded as a single part, can be manufactured entirely according to its drawing and thus be considered to be free of defects. Its length can, for example, be 0.5 mm longer than the nominal length within permissible tolerances. At the same time, for example, a vehicle door can also be made 0.5 mm longer than its nominal length. Although both individual parts are considered to be free of defects, it can happen that they do not fit together in the assembled state, because tolerances permissible in themselves accumulate disadvantageously. This then has to be corrected laboriously by reworking.

A further problem arises because, for example, a worker can evaluate his work result only after the assembly has been carried out and therefore must largely complete the assembly process before the abovementioned problems can be detected. Here, as well, there is an increased amount of rework required.

US 2014/035994A1 discloses a method for producing an assembly in which automated assembly steps are carried out by means of robots. Parts of a vehicle body are positioned. Gap dimensions are monitored automatically. If a gap dimension does not meet the quality requirements, the corresponding assembly is rejected as defective.

### SUMMARY OF THE INVENTION

It is therefore an object of the present invention to improve methods for producing assemblies such that rework and unnecessary work steps are avoided.

In an exemplary embodiment, the invention relates to a method for producing an assembly comprising the steps:

a) performing manual assembly steps;
b) automated checking during the assembly steps whether assembly results meet defined quality requirements;
c) providing immediate feedback if an assembly result does not meet the quality requirements.
d) performing an immediate correction by the worker.

In other words, mounting of components takes place here, for example, according to dimensional specifications, using a system for worker guidance.

In this regard, checking of the work result and giving immediate feedback to the worker occur automatically. An immediate correction is then possible for the worker. This avoids further assembly steps being carried out in vain, because the error is pointed out in good time. Technical solutions for the automated checking of products, for example, for optical quality control, are known from other fields and can be selected accordingly by the skilled artisan and supplemented by the feedback function on the basis of the teaching disclosed herein.

The method of the invention plays a role preferably when fitting body shell components, after changing parts due to defects found in the paint, or also when installing other add-on parts.

A further aspect of the invention relates to an assembly produced in a method of the invention according to the preceding description.

In an exemplary embodiment of the assembly of the invention, it is provided that the assembly is a vehicle.

Summarized again in other words, the invention relates to a method for producing an assembly. It is provided that manufacturing defects and redundant work steps are preventively avoided.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which are given by way of illustration only, and thus, are not limitive of the present invention, and wherein the sole FIGURE shows a block diagram of the sequence of a further method of the invention for producing an assembly.

### DETAILED DESCRIPTION

The FIGURE shows a block diagram of the sequence of a method of the invention for producing an assembly.

Manual assembly steps are carried out in a first method step a).

In a second method step b), an automated check takes place during the assembly steps in step a) whether assembly results meet defined quality requirements.

In a third method step c) immediate feedback is then provided if an assembly result does not meet the quality requirements.

An immediate correction occurs in a fourth method step d).

The assembly by way of example is a vehicle.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing an assembly, the method comprising:
performing manual assembly steps by a worker;
automated checking during the assembly steps whether assembly results meet defined quality requirements;
providing immediate feedback to the worker if an assembly result does not meet the quality requirements; and
performing an immediate correction by the worker.

2. An assembly produced by the method according to claim 1.

3. The assembly according to claim 2, wherein the assembly is a vehicle.
